(19) United States
(12) Patent Application Publication
(10) Pub. No.: US 2006/0093506 A1
(43) Pub. Date: May 4, 2006

(54) Scroll compressor

(75) Inventor: Dong-Han Kim, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/178,450

(22) Filed: Jul. 12, 2005

(30) Foreign Application Priority Data
Nov. 3, 2004 (KR) 88965/2004
Apr. 18, 2005 (KR) 32099/2005

(51) Int. Cl. F01C 1/02; F04C 2/00; F01C 1/063; F04C 18/00; F03C 2/00

(52) U.S. Cl. 418/55.1

(57) ABSTRACT

A scroll compressor includes an orbiting scroll orbiting and having a boss in which an eccentric portion of a rotating shaft is inserted, a main frame having a pocket in which a boss of the orbiting scroll is inserted and a thrust bearing surface to which a thrust bearing surface of the orbiting scroll is supported, and an elastic support portion installed at an upper surface of the main frame and functioning as a buffer so as to prevent abrasion of the thrust bearing surface by being elastically deformed when the orbiting scroll is deformed. Thus, although the orbiting scroll is deformed during compression, the scroll compressor can reduce a friction loss between the thrust bearing surfaces of the orbiting scroll and the main frame and prevent abrasion of the thrust bearing surfaces.

### BACKGROUND OF THE INVENTION

1. Field of the Invention

The present invention relates to a scroll compressor and particularly, to a scroll compressor capable of preventing abrasion between thrust bearing surfaces of a main frame and an orbiting scroll and improving efficiency of a compressor.

2. Description of the Background Art

In general, a scroll compressor is a high efficiency low noise compressor which is being widely used in the field of air conditioner. In the scroll compressor, two scrolls orbit relative to each other, forming a plurality of compression chambers. As the compression chambers continuously move toward the center with the volume changing, a fluid is successively sucked, compressed and discharged.

FIG. 1 is a sectional view of a scroll compressor in accordance with the conventional art.

The scroll compressor in accordance with the conventional art includes a casing 106 having a hermetic space and connected to a suction pipe 102 through which a fluid is sucked and to a discharge pipe 104 through which a compressed fluid is discharged, a driving motor 108 disposed at a lower side of the casing 106 and generating a driving force, a compression unit 110 disposed at an upper side of the casing 106 and connected to the driving motor 108 by a rotating shaft 112 to compress a fluid sucked through the suction pipe 120 and discharge the compressed fluid through the discharge pipe 104 by the rotation of the rotating shaft 112, and a main frame 114 mounted to an upper side of the casing 106, supporting the rotating shaft 112 rotatably and supporting the compression unit 110.

The driving motor 108 includes a stator 112 fixed in a circumferential direction of the casing 106 and a rotor 124 disposed at an inner circumferential surface of the stator 122 and fixed to the rotating shaft 112. When power is applied to the stator 122, the rotor 124 is rotated by the interaction of the stator 122 and the rotor 124 to thereby rotate the rotating shaft 112.

The compression unit 110 includes a fixed scroll 128 having a fixed wrap 126 of an involute shape and fixed to an upper side of the casing 106, and an orbiting scroll 132 having an orbiting wrap 118 of an involute shape corresponding to the fixed wrap 126 to form certain compression chambers 118 with the fixed wrap 126, orbitingly supported by the main frame 114 and orbiting when the rotating shaft 112 is rotated.

A separating plate 134 is mounted at an upper side of the fixed scroll 128 to separate the interior of the casing 106 into a high pressure chamber 136 and a lower pressure chamber 138. A discharging passage 140 through which a fluid compressed in the compression chamber 118 is discharged to the high pressure chamber 136 by the interaction of the fixed wrap 126 and the orbiting wrap 130 is formed at a center portion of the fixed scroll 128. Also, a check valve 142 for preventing the fluid, which has been discharged to the high pressure chamber 13, from flowing back to the low pressure chamber 138 is installed at an upper side of the discharging passage 140.

An Oldam ring 144 for guiding the orbiting scroll 132 to orbit is installed between the orbiting scroll 132 and the main frame 114.

A thrust bearing surface 150 is formed at a lower surface of the orbiting scroll 132 and a thrust bearing surface 150 by which the orbiting scroll 132 is orbitingly supported is formed at an upper surface of the main frame 114.

As shown in FIG. 2, a pocket 156 receiving therein a boss 152 which extends downwardly from the orbiting scroll 132 is formed at the main frame 114, and an oil discharge channel 160 through which oil filled in the pocket 156 is discharged to the outside is formed at the pocket 156.

An eccentric portion 154 formed at an upper side of the rotating shaft 112 is inserted in the boss 152 of the orbiting scroll 132. An oil supply passage 158 through which oil stored in a lower portion of the casing 106 is supplied to the thrust bearing surface 150 is formed at the rotating shaft 112.

The operation of the scroll compressor in accordance with the conventional art will now be described.

When power is applied to the stator 122 of the driving motor 108, the rotor 124 is rotated by the interaction of the stator 122 and the rotor 124, and the rotating shaft 112 fixed to the rotor is rotated. Then, because the eccentric portion 154 of the rotating shaft 112 is inserted in the boss 152 of the orbiting scroll 132, the orbiting scroll 132 orbits interacting with the fixed scroll 128, so that a gas having introduced into the compression chamber 118 is compressed and flows into the high pressure chamber 136 through the discharging passage 140. The gas having introduced to the high pressure chamber 136 is discharged to the outside through the discharge pipe 104.

When the rotating shaft 112 is rotated, oil stored in the lower portion of the casing 106 is ascended through the oil supply passage 158 and dispersed from an end portion of the rotating shaft 112. The oil dispersed in such a manner is collected in the pocket 156 of the main frame 114 after passing between the eccentric portion 154 of the rotating shaft 112 and the boss 152 of the orbiting scroll 132. The oil collected in the pocket 156 is supplied to the thrust bearing surfaces 150 of the main frame 114 and the orbiting scroll 132 by agitation of the boss 152 when the orbiting scroll 132 orbits.

However, the scroll compressor in accordance with the conventional art has the following problem. Because the oil is filled in the pocket 156 of the main frame 114, the boss of the orbiting scroll 132 orbits, submerged by the oil, and accordingly generates the agitation resistance, which degrades efficiency of the driving motor and deteriorates the performance of the compressor.

Also, as shown in FIG. 3, in the scroll comrpessor in accordance with the conventional art, when compressed between the orbiting scroll 132 and the fixed scroll 128, the fluid moves to the center of the compression chamber 118, reducing the volume of the chamber and accordingly the pressure of the compression chamber 118 of a center side is increased, which contributes to the deformation of the center portion of the orbiting scroll 132, such as downward bending thereof. Then, because the thrust bearing surface 150 of the orbiting scroll 132 orbits pressing the thrust bearing surface 150 of the main frame 114, abrasion of the thrust bearing surfaces 150 occurs, and a driving force of the driving motor 108 is increased, thereby reducing energy efficiency and causing damage to the driving motor 108.

### SUMMARY OF THE INVENTION

Therefore, an object of the present invention is to provide a scroll compressor capable of preventing abrasion of thrust bearing surfaces and improving efficiency of a compressor by providing an elastic support portion to a main frame and reducing frictional resistance between a thrust bearing surface of an orbiting scroll and a thrust bearing surface of the main frame when the orbiting scroll is deformed during compression.

Another object of the present invention is to provide a scroll compressor capable of improving efficiency of a motor and performance of a compressor by preventing oil from being filled in a pocket of the main frame and minimizing agitation resistance of a boss of the orbiting scroll which is in an orbiting motion.

To achieve these and other advantages and in accordance with the purpose of the present invention, as embodied and broadly described herein, there is provided a scroll compressor comprising: an orbiting scroll orbiting and having a boss in which an eccentric portion of a rotating shaft is inserted; a main frame having a pocket in which a boss of the orbiting scroll is inserted and a thrust bearing surface to which a thrust bearing surface of the orbiting scroll is supported; and an elastic support portion installed at an upper surface of the main frame and functioning as a buffer so as to prevent abrasion of the thrust bearing surface by being elastically deformed when the orbiting scroll is deformed.

The elastic support portion is formed such that an upper surface of an inner side of the main frame has a disc shape having its own elastic force by a groove formed in an inner circumferential surface of the pocket of the main frame in a circumferential direction.

The elastic support portion includes a mounting groove stepped on an inner circumferential surface of the pocket of the main frame and an elastic member installed in the mounting groove, and elastically supporting the thrust bearing surface of the orbiting scroll.

To achieve these and other advantages and in accordance with the purpose of the present invention, as embodied and broadly described herein, there is provided a scroll compressor comprising: an orbiting scroll having a boss in which an eccentric portion of a rotating shaft is inserted and orbiting; a main frame having a pocket in which the boss of the orbiting scroll is inserted and a thrust bearing surface by which a thrust bearing surface of the orbiting scroll is supported; an elastic support portion installed at an upper surface of the main frame and functioning as a buffer so as to prevent abrasion of the thrust bearing surface by being elastically deformed when the orbiting scroll is deformed; and an oil guide hole formed at the boss of the orbiting scroll and supplying oil, which has been supplied into the boss through an oil support passage of the rotating shaft, to the thrust bearing surfaces of the orbiting scroll and the main frame.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a sectional view of a scroll compressor in accordance with the conventional art;

FIG. 2 is a sectional view of a compression unit of the scroll compressor in accordance with the conventional art;

FIG. 3 is a view which illustrates an operational state of a deformed orbiting scroll in accordance with the conventional art;

FIG. 4 is a sectional view of a scroll compressor in accordance with the present invention;

FIG. 5 is a sectional view of a compression unit of the scroll compressor in accordance with the present invention;

FIG. 6 is an enlarged view of part A of FIG. 5;

FIG. 7 is an enlarged view of part B of FIG. 5;

FIG. 8 is a view which illustrates an operational state of an elastic support portion that supports a rotating shaft in accordance with the present invention;

FIG. 9 is a view which illustrates an operational state of an elastic support portion that supports an orbiting scroll in accordance with the present invention;

FIG. 10 is a sectional view which illustrates an elastic support portion in accordance with a second embodiment of the present invention;

FIG. 11 is a sectional view which illustrates an elastic support portion in accordance with a third embodiment of the present invention;

FIG. 12 is a view which illustrates an operational state of the elastic support portion in accordance with the third embodiment of the present invention; and

FIG. 13 is a sectional view which illustrates the elastic support portion in accordance with a fourth embodiment of the present invention.

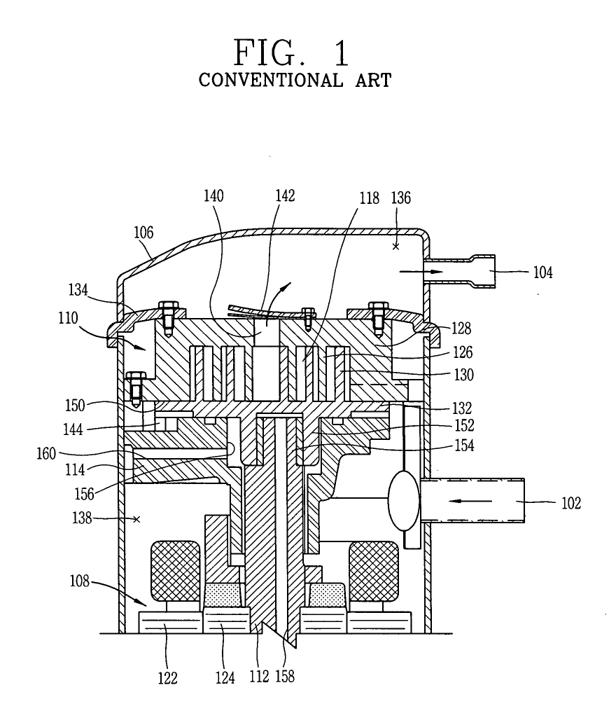

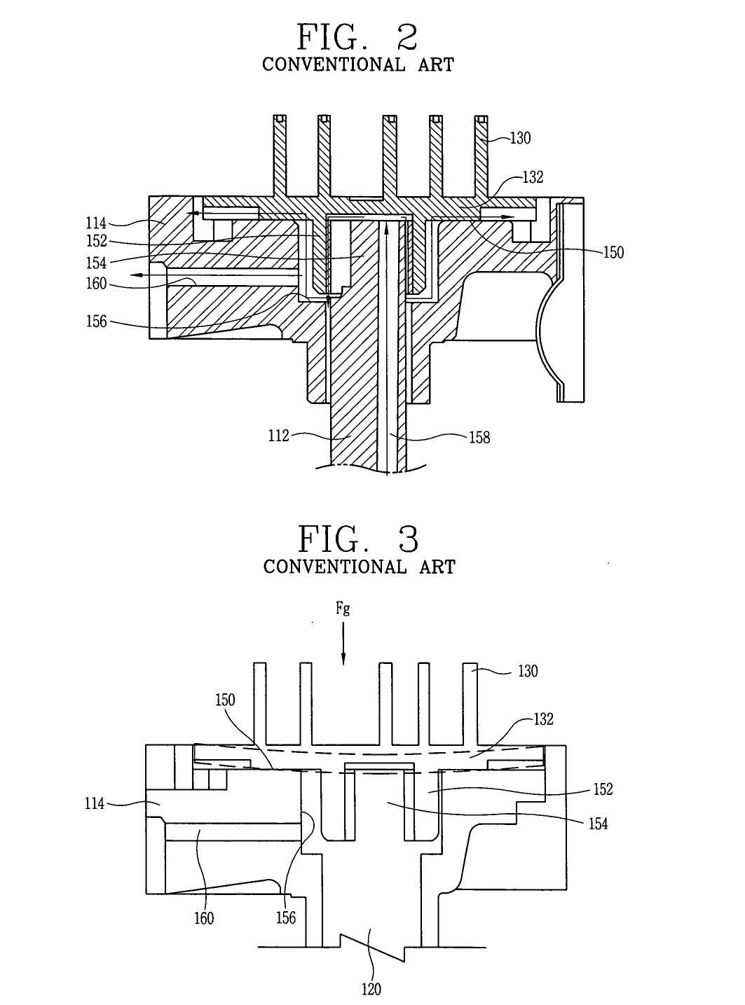

### DETAILED DESCRIPTION OF THE PREFERRED EMBODIMENTS

Reference will now be made in detail to the preferred embodiments of the present invention, examples of which are illustrated in the accompanying drawings.

There can be several embodiments of a scroll compressor, of which the most preferred ones will be described.

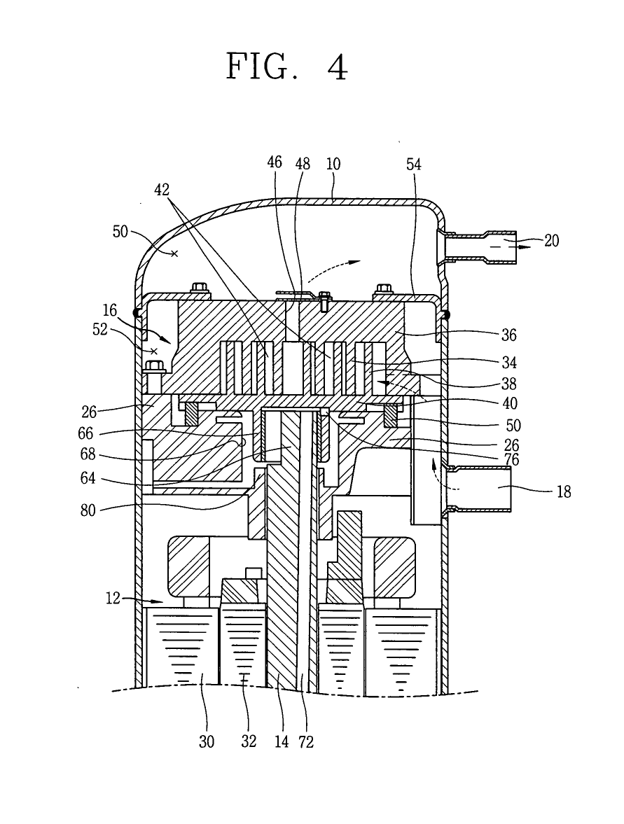

FIG. 4 is a sectional view of a scroll compressor in accordance with the present invention.

The scroll compressor in accordance with the present invention includes a casing 10 having a hermetic space and connected to a suction pipe 18 through which a fluid is sucked and to a discharge pipe 20 through which a compressed fluid is discharged, a driving motor 12 mounted in the casing 10 and generating a driving force, a compression unit 16 connected to the driving motor 12 by a rotating shaft 14 to compress a fluid and discharge the fluid to the outside when the driving motor 12 is driven, and a main frame 26 mounted inside the casing 10, rotatably supporting a rotating shaft 14 and supporting the compression unit 16.

The driving motor 12 includes a stator 30 fixed to an inner circumferential surface of the casing 10 and a rotor 32 disposed at an inner circumferential surface of the stator 30 and fixed to the rotating shaft 14. When power is applied to the stator 30, the rotor 32 is rotated by the interaction of the stator 30 and the rotor 32, thereby rotating the rotating shaft 14.

The compression unit 16 includes a fixed scroll 36 having a fixed vane 34 of an involute shape and fixed to an upper side of the casing 10, and an orbiting scroll 40 having an orbiting vane 38 of an involute shape corresponding to the fixed vane 34 to form certain compression chambers 42, orbitingly supported by the main frame 26, and orbiting when the rotating shaft 14 is rotated.

A separating plate 54 for dividing the interior of the casing 10 into a high pressure chamber 50 and a low pressure chamber 52 is fixed to an upper edge of the fixed scroll 36, a discharge hole 46 through which gas compressed by the interaction of the fixed vane 34 and the orbiting vane 38 is discharged is formed at the center of the fixed scroll 36, and a check valve 48 for opening and closing the discharge hole 46 to prevent a fluid from flowing back is installed at an upper surface of the fixed scroll 36.

An Oldam ring 50 for guiding the orbiting scroll 40 to orbit is installed between the orbiting scroll 40 and the main frame 26.

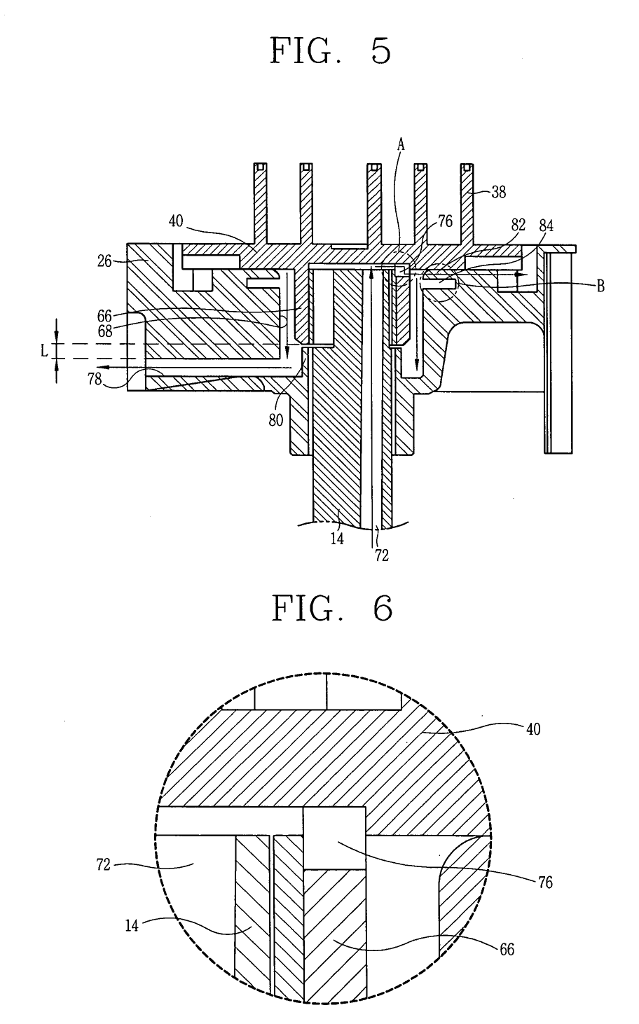

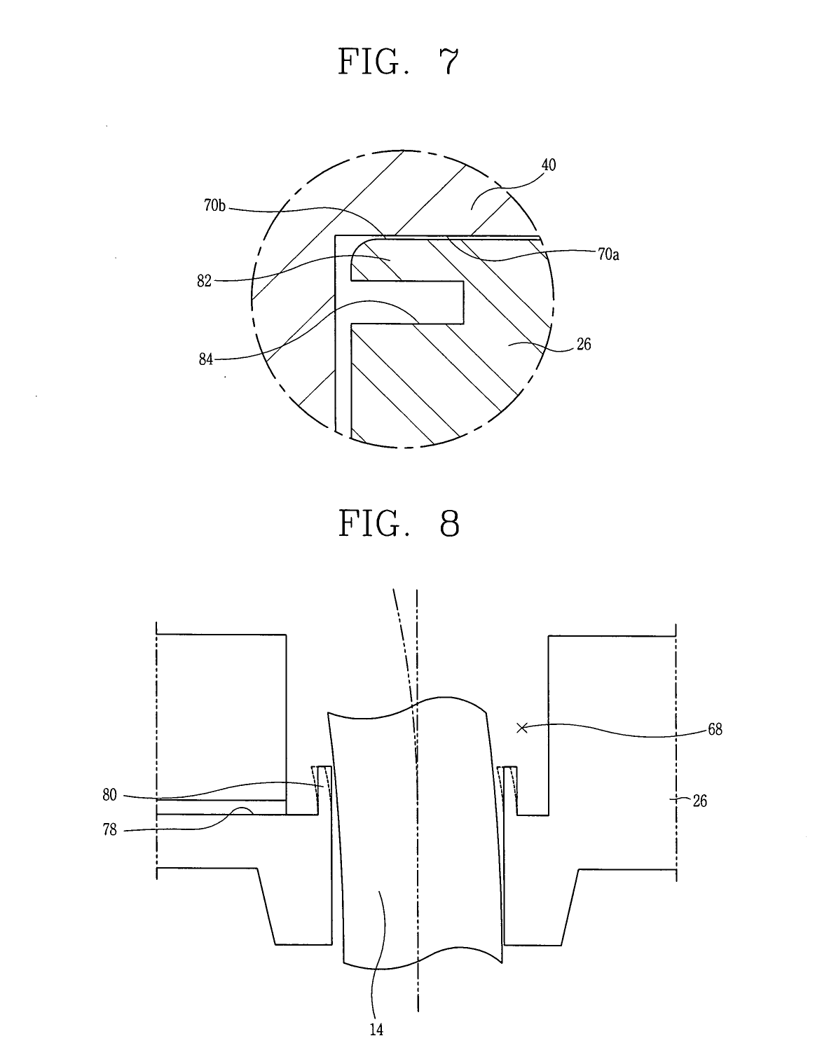

FIG. 5 is a sectional view of a compression unit in accordance with the present invention, FIG. 6 is an enlarged view of part A of FIG. 5, and FIG. 7 is an enlarged view of part B of FIG. 5.

A thrust bearing surface 70a is formed at a lower surface of the orbiting scroll 40 and a thrust bearing surface 70b by which the orbiting scroll 40 is rotatably supported is formed at an upper surface of the main frame 26.

The main frame 26 has at its center a pocket 68 in which a boss 66 of the orbiting scroll 40 is inserted. A boss 66 which is placed within the pocket 68 of the main frame 26 and which an eccentric portion 64 of the rotating shaft 16 is inserted in is formed at a lower side of the orbiting scroll 40. An oil supply passage 72 through which oil stored in a lower portion of the casing 10 is supplied to the thrust bearing surfaces 70 is formed at the rotating shaft 16.

As shown in FIG. 6, an oil guide hole 76 for guiding oil, which is dispersed into the boss 66 through the oil supply passage 72, to the thrust bearing surfaces 70 of the main frame 26 and the orbiting scroll 40 is formed at the boss 66 of the orbiting scroll 40.

The oil guide hole 76 is penetratingly formed such that the inside and the outside of the boss 66 are connected and performs guiding on oil so that the oil introduced into the boss 66 can be guided directly to the thrust bearing surfaces 70a and 70b without passing through the pocket 68.

Such an oil guide hole 76 is formed at a position closest to the oil supply passage 72, thereby allowing the oil to be smoothly discharged by a centrifugal force. One or more oil guide holes 76 are formed in a circumferential direction of the boss 66. Also, one or more guide holes 76 may be formed in a radial direction of the boss 66 or inclined along the direction in which the rotating shaft 14 is rotated.

After the oil having been supplied through the oil supply passage 72 of the rotating shaft 14 is supplied to the thrust bearing surfaces 70 through the oil guide hole 76, the remaining oil is discharged to the outside through an oil discharge hole 78 formed at the pocket 68.

The oil discharge hole 78 is formed at a bottom surface of the pocket 68 in a radial direction to discharge oil, which has been introduced to the pocket 68, to the outside. Also, the oil discharge hole 78 may be inclined downwardly from an inlet toward an outlet so that the oil can be more smoothly discharged. Here, because the oil discharge hole 78 is disposed under an end portion of the boss 66 of the orbiting scroll at a distance as long as height (L), the boss 66 can be prevented from being submerged by the oil.

An elastic support portion 80 which reduces a friction loss by elastically supporting the rotating shaft 14 when the rotating shaft 14 is eccentrically rotated is formed at the bottom surface of the pocket 68.

As shown in FIG. 8, the elastic support portion 80 extends upwardly from the bottom surface of the pocket 68 as a cylindrical shape, is disposed at an outer circumferential surface of the rotating shaft 14, and has its own-elastic force. Thus, when the rotating shaft 14 is eccentrically rotated, the elastic support portion 80 is elastically deformed to elastically support the rotating shaft 14.

An elastic support portion 82 is formed at the main frame 26. Here, when a center side of the orbiting scroll 40 is downwardly deformed, the elastic support portion 82 is elastically deformed to function as a buffer, thereby preventing the abrasion of the thrust bearing surfaces 70a and 70b of the orbiting scroll 40 and the main frame 26.

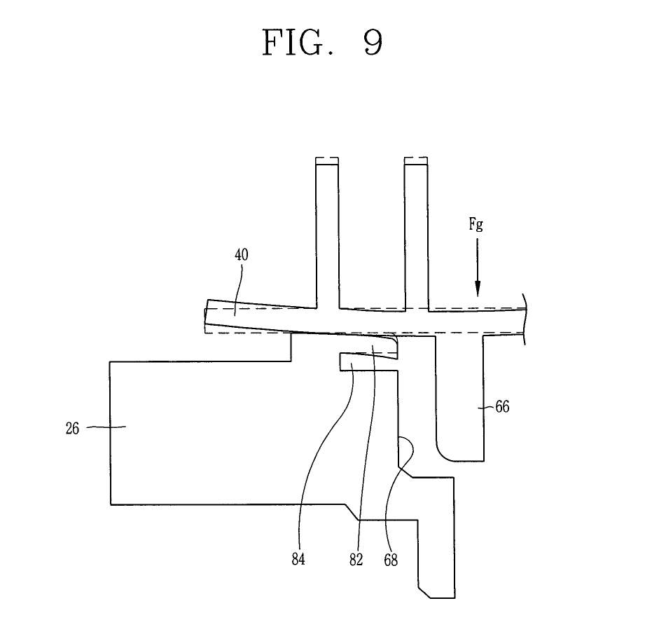

As shown in FIG. 9, the elastic support portion 82 is formed by forming a groove 84 at an upper end side of an inner circumferential surface of the main frame 26 to a certain depth. Namely, as the groove 84 having a certain depth is formed at the upper end side of the inner circumferential surface of the main frame 26 in a circumferential direction, the upper end of the inner circumferential surface of the main frame 26 is formed as a thin disc shape to become an elastic support portion 82 that is elastically deformed by itself.

The elastic support portion 82 gets thinner toward its center from the edge, and its corner portion coming in contact with the thrust bearing surface 70a of the orbiting scroll 40 is formed rounded.

The operation of the scroll compressor in accordance with the present invention will now be described.

When power is applied to the driving motor 12, the rotor 132 is rotated by the interaction between the rotor 32 and the stator 30 and the rotating shaft 14 connected to the rotor 32 is thusly rotated. Then, because the eccentric portion 64 of the rotating shaft 14 is inserted in the boss 66 of the orbiting scroll 40, the orbiting scroll 40 orbits interacting with the fixed scroll 36. By the interaction between the orbiting scroll 40 and the fixed scroll 36, a gas having introduced into the compression chamber 118 is compressed, introduced to the high pressure chamber 50 through a discharging passage 48 and discharged to the outside through the discharge pipe 20.

Here, when the rotating shaft 14 is rotated, oil stored in a lower portion of the casing 10 is ascended through the oil supply passage 72 and supplied from an end portion of the rotating shaft 14 into the boss 66 of the orbiting scroll 40.

The oil having been supplied into the boss 66 of the orbiting scroll 40 is supplied to the thrust bearing surfaces 70a and 70b of the orbiting scroll 40 and the main frame 26 through the oil guide hole 76 formed at the boss 66 of the orbiting scroll 40. After the oil is supplied to the thrust bearing surface 70a and 70b, the remaining oil is introduced to a lower portion of the pocket 68 and then is discharged to the outside through the oil discharge hole 78.

Here, because the oil having been supplied into the boss 66 through the oil supply passage 72 is supplied directly to the thrust bearing surfaces 70a and 70b through the oil guide hole 76 without going by way of the pocket 68, and the remaining oil is discharged through the oil discharge hole 78 formed at the pocket 68, the oil can be prevented from staying in the pocket 68. Accordingly, the boss 66 of the orbiting scroll 40 can be prevented from being submerged by the oil, thereby preventing the agitation resistance of the boss 66 of the orbiting scroll 40.

Also, because an outer circumferential surface of the rotating shaft 14 is elastically supported by the elastic support portion 80 formed inside the pocket 68 of the main frame 26, the elastic support portion 80 elastically supports the rotating shaft 14 being eccentrically rotated, thereby reducing the rotation resistance of the rotating shaft 14 and thusly preventing damage to the motor.

In addition, as mentioned above, a refrigerant introduced into the compression chamber 42 formed between the orbiting vane 38 of the orbiting scroll 40 and the fixed vane 34 of the fixed scroll 36 is gradually compressed while being moved toward a central side of the compression chamber 42 from an edge side of the compression chamber 42. For this reason, the temperature and pressure is rapidly increased at the central side of the compression chamber 42 and accordingly, the central side of the orbiting scroll 40 is bent downwardly by heat or pressure, thereby pressing the thrust bearing surface 70b of the main frame 26. Here, the elastic support portion 82 formed at an inner circumferential surface of the main frame 26 is elastically deformed in a downward direction, working as a buffer, thereby reducing the friction loss between the orbiting scroll 40 and the main frame 26.

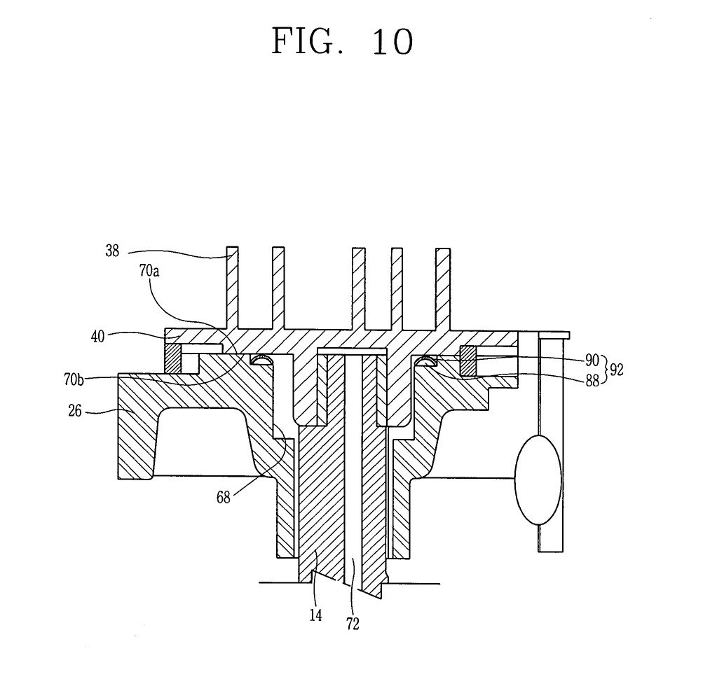

FIG. 10 is a sectional view which illustrates an elastic support portion of the scroll compressor in accordance with the second embodiment of the present invention.

The elastic support portion 92 in accordance with the second embodiment includes a mounting groove 88 stepped on an upper surface of the pocket 68 of the main frame 26 in a circumferential direction, and an elastic member 90 mounted to the mounting groove 88 and elastically supporting the thrust bearing surface 70a of the orbiting scroll 40.

The mounting groove 88 is stepped on an inner circumferential surface of an upper end of the main frame 26 as the shape of a circle or a circular arc. Preferably, the elastic member 90 is formed as a leaf spring having a wave form.

The elastic support portion 92 in accordance with the second embodiment elastically supports the thrust bearing surface 70a of the orbiting scroll 40 as the elastic member 90 is elastically deformed when the central side of the orbiting scroll 40 is deformed downwardly.

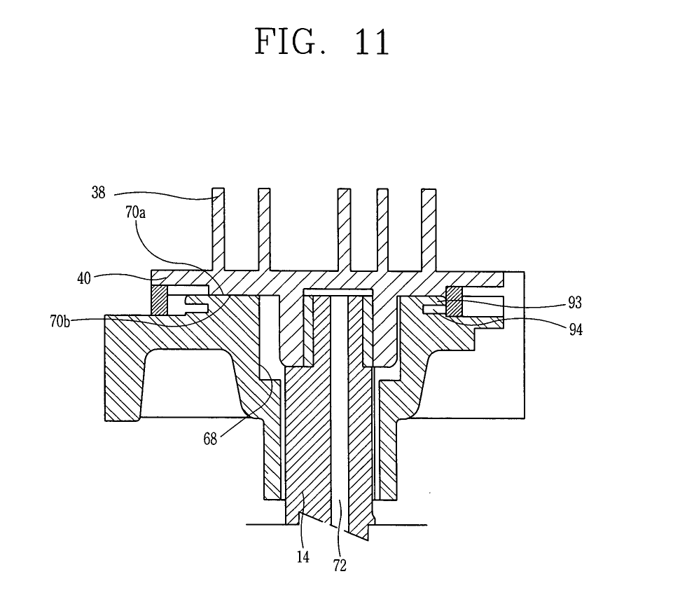

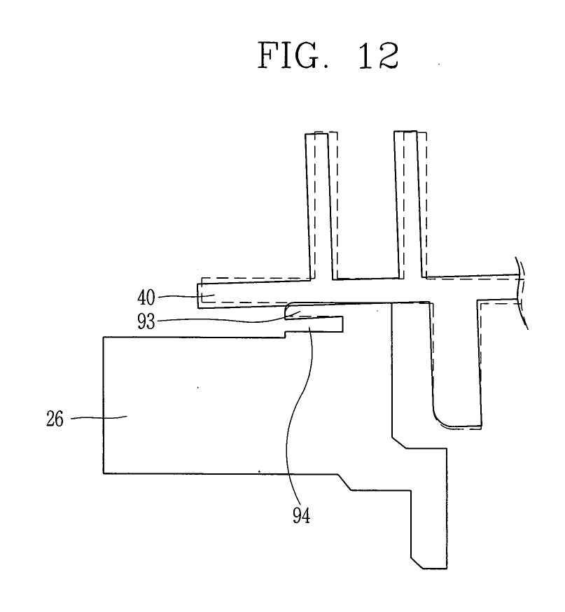

FIG. 11 is a sectional view which illustrates an elastic support portion of the scroll compressor in accordance with the third embodiment of the present invention, and FIG. 12 is a state diagram of the elastic support portion in accordance with the third embodiment of the present invention.

The elastic support portion 93 in accordance with the third embodiment is formed such that a groove 94 is formed in an outer circumferential surface of an upper end of the main frame 26 in a circumferential direction by chamfer processing, in order to prevent friction and abrasion between an edge of a lower surface of the main frame 26 and an edge of an upper surface of the orbiting scroll 40, which occur when the orbiting scroll 40 abnormally orbits with a larger radius or in an inclined state.

Namely, the elastic support portion 93 is formed as a thin disc shape in a circumferential direction of the outer circumferential surface of the upper end of the main frame 26, has its own elastic force, and works as a buffer by being elastically deformed when an edge of a lower surface of the orbiting scroll 40 is deformed downwardly, thereby preventing friction between the orbiting scroll 40 and the main frame 26.

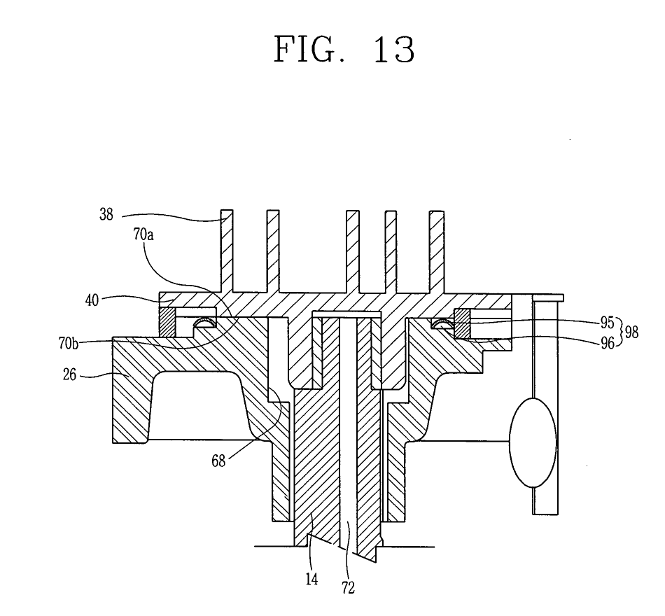

FIG. 13 is a sectional view of an elastic support portion of the scroll compressor in accordance with the fourth embodiment of the present invention.

The elastic support portion 98 in accordance with the fourth embodiment includes a mounting groove 96 stepped on an outer circumferential surface of an upper end of the main frame 26 in a circumferential direction, and an elastic member 95 mounted in the mounting groove 96 and elastically supporting an edge of a lower surface of the orbiting scroll 40.

Preferably, the elastic member 95 is formed as a leaf spring of a wave form.

The effect of the scroll compressor in accordance with the present invention constructed and operated in the aforementioned manner will now be described.

When an orbiting scroll is deformed during the operation of a compressor, an elastic support portion formed at a main frame elastically supports the orbiting scroll, thereby reducing a friction loss between thrust bearing surfaces of the orbiting scroll and the main frame. Accordingly, efficiency of a motor can be improved, abrasion of the thrust bearing surfaces can be reduced, and reliability of a compressor can be improved.

Also, because an oil guide hole is formed at a boss of the orbiting scroll to supply oil directly to the thrust bearing surfaces of the orbiting scroll and the main frame, the oil is prevented from being filled in a pocket of the main frame and accordingly, the agitation resistance of the boss of the orbiting scroll can be prevented.

In addition, an elastic support portion is formed in the pocket of the main frame to elastically support an outer circumferential surface of the rotating shaft, thereby reducing the friction loss due to eccentric rotation of the rotating shaft and thus improving efficiency of the motor.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A scroll compressor comprising:
an orbiting scroll orbiting and having a boss in which an eccentric portion of a rotating shaft is inserted;
a main frame having a pocket in which a boss of the orbiting scroll is inserted and a thrust bearing surface by which a thrust bearing surface of the orbiting scroll is supported; and
an elastic support portion installed at an upper surface of the main frame and functioning as a buffer so as to prevent abrasion of the thrust bearing surface by being elastically deformed when the orbiting scroll is deformed.

2. The scroll compressor of claim 1, wherein the elastic support portion is formed such that an upper surface of an inner side of the main frame has a disc shape having its own elastic force by a groove formed in an inner circumferential surface of the pocket of the main frame in a circumferential direction.

3. The scroll compressor of claim 1, wherein the elastic support portion is formed as a plurality of circular arcs by a plurality of grooves that are formed at regular intervals in an inner circumferential surface of the pocket of the main frame.

4. The scroll compressor of claim 2, wherein the elastic support portion gets thinner inwardly.

5. The scroll compressor of claim 2, wherein a corner portion of the elastic support portion, which comes in contact with the thrust bearing surface of the orbiting scroll, is rounded.

6. The scroll compressor of claim 1, wherein the elastic support portion comprises:
a mounting groove stepped on an inner circumferential surface of the pocket of the main frame in a circumferential direction; and
an elastic member installed in the mounting groove and elastically supporting the thrust bearing surface of the orbiting scroll.

7. The scroll compressor of claim 6, wherein the elastic member is formed as a leaf spring.

8. The scroll compressor of claim 1, wherein the elastic support portion is formed such that an upper surface of an outer side of the main frame is formed as a disc shape having its own elastic force by a groove formed in an outer circumferential surface of the main frame in a circumferential direction.

9. The scroll compressor of claim 8, wherein the elastic support portion gets thinner outwardly.

10. The scroll compressor of claim 1, wherein the elastic support portion comprises:
a mounting groove stepped on an outer circumferential surface of the main frame in a circumferential direction; and
an elastic member installed in the mounting groove and elastically supporting the thrust bearing surface of the orbiting scroll.

11. The scroll compressor of claim 10, wherein the elastic member is formed as a leaf spring.

12. A scroll compressor comprising:
an orbiting scroll having a boss in which an eccentric portion of a rotating shaft is inserted and orbiting;
a main frame having a pocket in which the boss of the orbiting scroll is inserted and a thrust bearing surface by which a thrust bearing surface of the orbiting scroll is supported;
an elastic support portion installed at an upper surface of the main frame and functioning as a buffer so as to prevent abrasion of the thrust bearing surface by being elastically deformed when the orbiting scroll is deformed; and
an oil guide hole formed at the boss of the orbiting scroll and supplying oil, which has been supplied into the boss through an oil support passage of the rotating shaft, to the thrust bearing surfaces of the orbiting scroll and the main frame.

13. The scroll compressor of claim 12, wherein the elastic support portion is formed such that an upper surface of an inner side of the main frame has a disc shape having its own elastic force by a groove formed in an inner circumferential surface of the pocket of the main frame in a circumferential direction.

14. The scroll compressor of claim 12, wherein the elastic support portion comprises:
a mounting groove stepped on an inner circumferential surface of the pocket of the main frame in a circumferential direction; and
an elastic member installed in the mounting groove and elastically supporting the thrust bearing surface of the orbiting scroll.

15. The scroll compressor of claim 12, wherein the oil guide hole is formed at a distance closest to the oil supply passage.

16. The scroll compressor of claim 12, wherein one or more oil guide holes are formed in a circumferential direction of the boss.

17. The scroll compressor of claim 12, wherein an oil discharge hole through which oil having been introduced into the pocket is discharged to the outside is formed at a bottom surface of the pocket of the main frame.

18. The scroll compressor of claim 17, wherein the oil discharge hole is formed under a lower end of the boss of the orbiting scroll.

19. The scroll compressor of claim 12, wherein an elastic support portion elastically supporting the rotating shaft is formed at the pocket of the main frame.

20. The scroll compressor of claim 19, wherein the elastic support portion extends upwardly from the center of the pocket as a cylindrical shape to encompass an outer circumferential surface of the rotating shaft and has its own elastic force.
